(19) United States
(12) Patent Application Publication
(10) Pub. No.: US 2006/0152213 A1
(43) Pub. Date: Jul. 13, 2006

(54) Apparatus for detecting the presence of electrically-conductive debris

(76) Inventors: Michael Frank Thompson, Overton Hampshire (GB); Brian Pollard, Kent (GB)

Correspondence Address: PETERS VERNY JONES & SCHMITT, L.L.P., 425 SHERMAN AVENUE, SUITE 230, PALO ALTO, CA, 94306, US

(21) Appl. No.: 10/548,574

(22) PCT Filed: Mar. 9, 2004
(86) PCT No.: PCT/GB04/01007

§ 371 Date: Feb. 23, 2006

(30) Foreign Application Priority Data
Mar. 11, 2003 (GB) 03055589
Jun. 26, 2003 (GB) 03149598

(51) Int. Cl. G01N 27/74

(52) U.S. Cl. 324/204

(57) ABSTRACT

Apparatus for detecting the presence of electrically-conductive debris in a flow passageway has a bridge circuit with four arms. One arm of the bridge has a coil arranged to monitor the flow passageway. Operating circuitry provides alternating current across one diagonal of the bridge, monitoring circuitry monitors imbalance in the bridge across the other diagonal of the bridge, and balancing circuitry responds to an output of the monitoring circuitry for adjusting the value of at least one component of the bridge circuit in such a way to reduce imbalance in the bridge.

The present invention relates to apparatus for detecting the presence of electrically-conductive debris in a flow passageway.

Such apparatus has a number of applications, among which is the detection of metallic particles in the lubricating oil of a machine such as an internal combustion engine.

A number of devices for detecting the presence of electrically-conductive debris in a flow passageway are known but these tend to suffer from one or more of the following defects:
(i) Frequent manual adjustment is required to ensure reliable detection;
(ii) Some devices using more than one coil are sensitive to the relative positions of the coils, and thus to problems caused by vibrations, temperature change and the like;
(iii) The circuitry is susceptible to temperature change and temperature level; compensation circuits can cause delay in the device becoming operational at the required sensitivity
(iv) Internal noise limits sensitivity to small particles

It is accordingly an object of the present invention to at least partially mitigate some of the above-mentioned deficiencies.

According to a first aspect of the present invention there is provided apparatus for detecting the presence of electrically-conductive debris in a flow passageway, the apparatus comprising a bridge circuit having four arms, one arm of the bridge comprising a coil arranged to monitor the flow passageway, operating circuitry for providing alternating current across one diagonal of the bridge, monitoring circuitry for monitoring imbalance in the bridge across the other diagonal of the bridge, and balancing circuitry responsive to an output of the monitoring circuitry for adjusting the value of at least one component of the bridge circuit in such a way to reduce imbalance in the bridge.

The apparatus may comprise only a single coil.

The operating circuitry, the monitoring circuitry, the balancing circuitry and components of the bridge circuit other than the coil may be disposed remote from the flow passageway.

The balancing circuitry may be arranged to control at least one of the group comprising capacitive reactance, inductive reactance and resistance of said at least one component.

The monitoring circuitry may comprise synchronous detectors for measuring in-phase and quadrature components of voltage in said other diagonal of the bridge.

The operating circuitry may comprise circuitry for applying a sine wave across said one diagonal as said alternating current.

Said one arm may comprise the series circuit of said coil and a capacitor device, and the remaining three arms be formed of elements whose impedance effect is substantially resistive.

The capacitor device may be controllable.

The said one arm may comprise a transformer having a primary and secondary winding, the primary winding being disposed in series with the capacitive device and the secondary winding being connected to the said coil.

The balancing circuitry may comprise a controllable capacitance connected in parallel with a fixed capacitor in said one arm.

The controllable capacitance may comprise of a fixed capacitor and circuitry for controllably feeding alternating current to the capacitor, whereby the effect of the fixed capacitor is controlled.

The balancing circuitry may comprise a controllable resistance connected in parallel with a fixed resistor in one of the arms of the bridge circuit.

According to a second aspect of the present invention there is provided apparatus for detecting the presence of electrically-conductive debris in a flow passageway, the apparatus comprising a coil arranged to monitor the passageway, drive circuitry for providing alternating current through the coil, sensing circuitry for monitoring current flow in the coil, the sensing circuitry comprising compensation circuitry for compensating for ageing and temperature effects, wherein the drive circuitry comprises components which with the coil form a bridge circuit such that the coil is disposed in one arm of the bridge circuit, and wherein the compensation circuitry is arranged to control at least one of the group comprising capacitive reactance, inductive reactance and resistance of one of more said components.

The apparatus may comprise only a single coil.

The operating circuitry, the monitoring circuitry, the balancing circuitry and components of the bridge circuit other than the coil may be disposed remote from the flow passageway.

The sensing circuitry may comprise synchronous detectors for measuring in-phase and quadrature components of voltage in a diagonal of the bridge circuit.

The bridge circuit may comprise four arms, said one arm comprising a series circuit of said coil and a capacitive device, and the remaining three arms being formed of elements whose impedance effect is substantially resistive.

The drive circuitry may comprise a source of sine wave oscillations coupled to one diagonal of the bridge circuit.

The capacitive device may be controllable. The said one arm may comprise a transformer having a primary and a secondary winding, the primary winding being disposed in series with the capacitive device and the secondary winding being connected to the said coil.

The compensation circuitry may comprise a controllable capacitance connected in parallel with a fixed capacitor in said one arm.

The controllable capacitance may comprise a fixed capacitor and circuitry for controllably feeding alternating current to the capacitor, whereby the effect of the fixed capacitor is controlled.

The compensation circuitry may comprise a controllable resistance connected in parallel with a fixed resistor in one of the said remaining arms of the bridge circuit.

The controllable resistance may comprise a fixed resistor and circuitry for controllably feeding alternating current of the resistor, whereby the effect of the fixed resistor is controlled.

Plural coils may be provided, at least one of which has an axis that is not aligned with the flow passage axis, so as to determine the shape of any particles, or to ensure detection of highly-asymmetric particles such as thin wide particles.

Embodiments of the invention will now be described by way of example only, with reference to the accompanying drawings in which

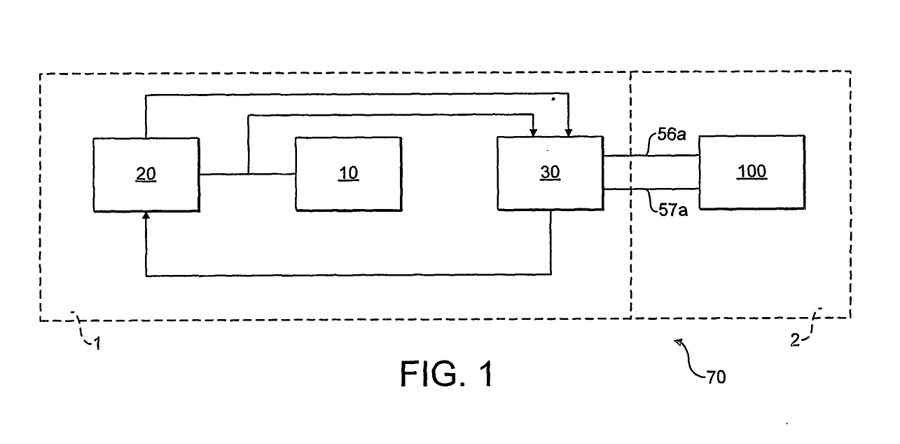

FIG. 1 shows a high level diagram of apparatus for detecting the presence of electrically-conductive debris in a flow passageway embodying the present invention,

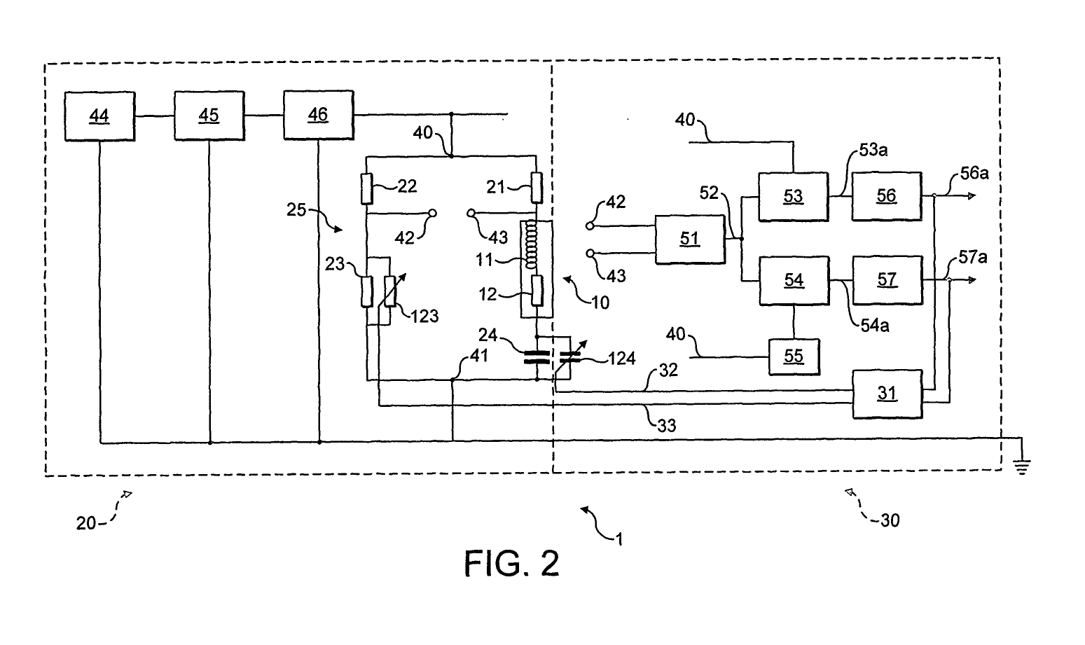

FIG. 2 shows a block diagram of part of the apparatus of FIG. 1,

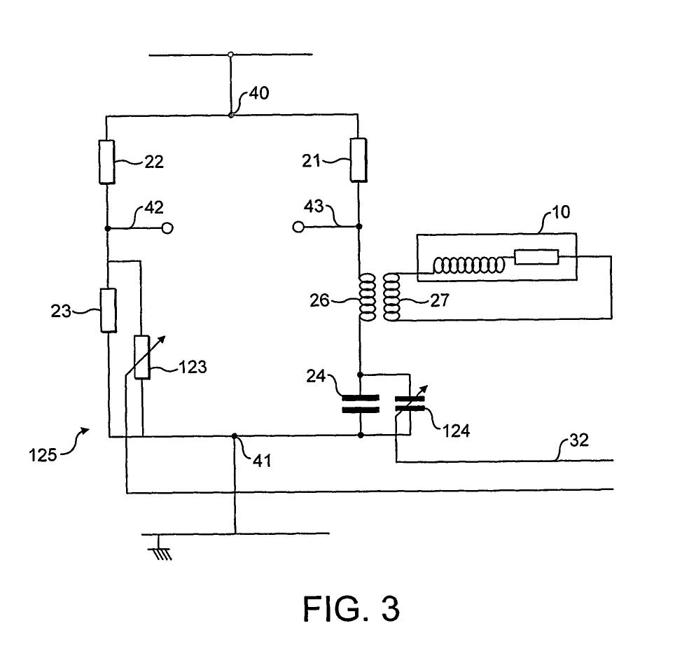

FIG. 3 shows a block diagram of a modification of part of the apparatus of FIG. 2,

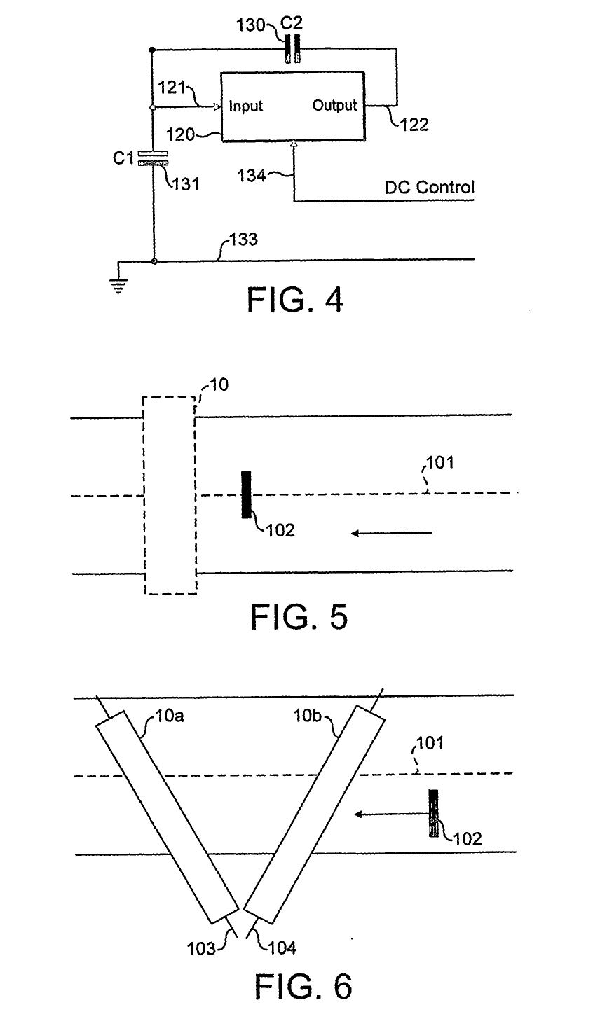

FIG. 4 shows an example of a variable impedance circuit suitable for use in apparatus in accordance with the invention,

FIG. 5 shows a partial cut-away view of a particle moving in a flow passage and about to pass through a coil of apparatus embodying the invention, and

FIG. 6 shows a partial cut-away view of a particle moving in a flow passage and about to pass through coils of another apparatus embodying the invention.

In the various Figures like reference numerals refer to like parts.

Referring first to FIG. 1, apparatus (70) for detecting the presence of electrically conducted debris in a flow passageway includes a first part (1) which provides signals indicative of electrically-conductive debris, and a second part (2) which receives the signals representative of debris and responds to them.

The first part (1) consists of a sensing coil (10) powered by drive circuitry (20), and sensing circuitry (30) for monitoring current flow in the coil. The sensing circuitry (30) has outputs (56a, 57a) which are fed to the part (2). Part (2) includes, in this embodiment, analysis circuitry (100) that operates to discriminate the signals so as to detect the occurrence of a perturbation detected by the coil. The use of only one coil means that changes due to vibration or changes in dimension of a pipe defining the flow passageway cause less effect on the circuit output than is the case in devices using differential or other effects derived from more than one coil.

Referring to FIG. 2, coil (10) is shown figuratively as a pure inductance (11) serially connected to a resistive element (12). The coil (10) is arranged to monitor the flow passageway (not shown). Typically the coil (10) is wound on or around the outer periphery of piping defining the flow passageway. The drive circuitry (20) is arranged to provide alternating current through the coil and the sensing circuitry (30) monitors current flow in the coil (10). The sensing circuitry (30) includes compensation circuitry (31) for compensating for ageing and temperature effects in the remainder of the apparatus. The drive circuitry (20) in this embodiment has first to third fixed resistors (21, 22, 23) which, with the coil form a bridge circuit having four arms, such that the coil is disposed in one arm of the bridge circuit. The one arm of the bridge circuit consists of the series circuit of the coil (10) with a fixed capacitor (24), the fixed capacitor (24) being paralleled by an electronically controlled capacitor (124).

Where the fluid being monitored is expected either to be hot, or to have a wide variation in temperature, it is advantageous to dispose only the coil close to the passageway. The other integers are advantageously remote from the passageway to prevent temperature effects.

The bridge circuit (25) has a first node (40) common to the first and second resistors (21, 22) and a second node (41) common to the arm containing the coil (10) and the arm containing the resistor (23) such the path from first node (40) to third node (41) constitutes a first bridge diagonal. The bridge circuit (25) further has a third node (42) common to the second and third resistors (22, 23), and a fourth node (43) common to the first resistor (21) and the one arm containing the coil (10) and the fixed capacitor (24). In the embodiment shown, the coil (10) is connected to the fourth node (43) and the capacitor (24) to the second node—this is, however, not fundamental to the invention in its broadest concepts.

The bridge circuit (25) thus has a first arm (10, 24) containing the coil (10) and fixed capacitor (24), a second arm containing the first resistor (12), a third arm containing the second resistor (22) and a fourth arm containing the third resistor (23). A second diagonal on the bridge circuit (25) is formed between the third and fourth nodes (42, 43). The fourth arm further includes an electronically controllable resistor (123) parallel to the third resistor (23).

The drive circuitry (20) further includes a crystal oscillator (44), a harmonic-reducing low pass filter (45) receiving the output of the crystal oscillator and a power amplifier (46) receiving the output of the filter (45). The amplifier output is connected to the first node (40) of the bridge circuit (25). The second node (41) of the bridge circuit (25) constitutes a reference node to which are connected the reference node terminals of the crystal oscillator (44), low pass filter (45) and power amplifier (46). In this embodiment the reference node (41) is connected to earth. It would be possible to use a sine wave oscillator, but in the embodiment described, the oscillator has a square wave output. Suitable filter circuits are well known to those skilled in the art to allow substantially a sine wave output to power the bridge.

The sensing circuitry (30) has an input differential amplifier (51), whose two inputs are connected to the third and fourth nodes (42, 43) of the bridge circuitry (25). The differential amplifier (51) has a single ended output (52) connected to a first synchronous detector (53) and a second synchronous detector (54). The first synchronous detector (53) receives the voltage at the first node (40) as its alternating reference. The second synchronous detector (54) has a 90° phase shift circuit (55) connected to its reference terminal and the phase shift circuit (55) receives the voltage at the first node (40) as its input.

The first synchronous detector (53) has an output (53a) which provides the input to a first amplifier and filter circuit (56) in turn having an output (56a). The second synchronous detector (54) has an output (54a) which provides the input to a second amplifier and filter circuit (57) which in turn has an output (57a). The compensation circuitry (31) has two inputs which are connected respectively to the output (56a) of the first amplifier and filter circuit and the output (57a) of the second amplifier and filter circuit. The compensation circuitry (31) has two outputs in this embodiment, a first output (32) being connected to control the electronically controlled capacitor (124) and the second output (33) of the compensation circuitry is connected to control the value of the electronically controlled resistor (123). The compensation circuitry (31) is arranged further to monitor the bridge circuit to reduce imbalance in the bridge circuit (25).

Turning now to FIG. 3, a modification of the apparatus shown in FIG. 2 is shown. Comparison between FIGS. 2 and 3 shows that the bridge circuit (125) of FIG. 3 is substantially identical to the bridge circuit (25) in FIG. 2 with the exception of the fact that the coil (10) is not connected directly between the fourth node (43) and the fixed capacitor (24) but instead is coupled to the secondary winding (27) of a transformer (26, 27). The primary winding (26) of the transformer (26, 27) is, in this embodiment, connected between the node (43) and the fixed capacitor (24).

Operation of the embodiment of FIG. 2 will now be described.

The crystal oscillator (44) includes divider circuitry to provide a frequency of output of around 100 kHz. In the described embodiment a 25 MHz crystal is used and is divided in frequency by 256. The use of a high frequency crystal provides low susceptibility to vibration since the crystal is physically small. The output of the crystal oscillator is provided to the low pass filter (45) whose output has a low harmonic content which helps to keep the residual bridge output across nodes (42, 43) low enough in the bridge-balance condition so as to not overload the detectors (53, 54). After switch on, the loop including the compensation circuitry (31) operates to balance the bridge circuit (25) with the in-phase output (56a) providing retroactive control of the resistance of the electronically controlled resistor (123) so as to balance the bridge for changes in resistance of the coil (10) and the quadrature signal (57a) being used to control the reactance of the electronically controlled capacitor (124) to balance the bridge for changes in inductive reactance (11) of the coil (10). Under steady-state conditions with no debris passing through the coil, the compensation circuitry (31) receives the in-phase and quadrature signals and integrates these to provide control parameters for the electronically controlled capacitor and the electronically resistor (124, 123). The loop is such as to minimise the value of in-phase signal and quadrature signal. It will be understood that the fact that the second-fourth arms include only resistors means that the first arm containing the coil (10) and the capacitor (24) is also resistive when the bridge is balanced, this condition being achieved at resonance or the series-resonance circuit of the capacitors (24, 124) and the coil (10). To that end, the value of capacitance of the electronically controlled capacitor (124) is varied to maintain resonance at the drive frequency of around 100 kHz (actually nominally 97.5 kHz), in concert with the fixed capacitor (24).

Referring now to FIG. 4, a gain-controlled amplifier circuit (120) has a capacitor (130) connected between its input (121) and its output (122). The input (121) is connected to ground (123) via a fixed capacitor (131). A gain control input (124) to the amplifier (120) then allows the effective value of the capacitance shunting the input (121) to ground (123) to be varied. Hence the total capacitance between input (121) which consists of the sum of the fixed capacitance of the capacitor (131) and the effectively variable capacitor can be changed by the gain control input. Replacement of the capacitors (130, 131) by resistors can be used to provide a variable resistance circuit. Other variable resistance/capacitance circuits are known to the skilled person and can be used instead.

The time constants of integration of the compensation or balancing circuitry (31) are chosen so that the signals produced by the passage of a particle through the coil are too fast materially to effect the tuning. In the embodiment chosen, the tuning has sufficient range to allow for ageing and temperature effects, while having sufficient precision to tune the bridge to better than one part in 4 million. Balance is achieved within 10 seconds of turning on the control circuit.

Using the device shown in FIG. 2 M50 particles down to 85 Microns can be detected using an oil temperature range of 20-150° C. flowing through the flow passageway. The device is able to respond to a change in coil impedance of about one part in 10 million.

Special measures may be taken to screen the drive circuitry to reduce radiated noise and to provide a low harmonic content in the drive circuitry power when the power is increased to 10 watts. Such a power input would allow particles as small as 25 Microns to be detected.

The modification shown in FIG. 3 may be used where lower frequencies than 100 kHz are used. Use of the lower frequency makes tuning the coil more difficult if the coil is serial to the capacitors but by use of the transformer coupling, this can be ameliorated. The use of the transformer also allows a balanced drive to the coil which enhances the noise rejection performance of the device: hence it may be useful to apply this modification to higher-frequency apparatus, as well.

The analyser circuitry (100) may be a simple presence detector which provides an output which indicates the presence of one or more particles in the flow passage. Alternatively, it may use the shape of the outputs on the output lines (56a, 57a) to provide an indication of the shape and size of the particle, or of successive particles whose presence is detected.

The shape of the coil must be selected according to the desired application. It will be appreciated that the particular shape selected is likely to be a compromise between sensitivity and flow through the flow passage. Clearly the sensitivity is improved by making the coil diameter less so that a particle would be larger in comparison. However, a smaller diameter core will necessarily require a smaller diameter flow passage and this is likely to restrict the oil flow. The apparatus described is advantageous over prior proposals for a number of reasons. Among these are the following:—
1. Only one coil is needed for each oil flow pipe.
2. The device is fully automatic and does not require any adjustments.
3. Will operate typically within 6 seconds of turn on.
4. by providing in-phase and quadrature output, particle discrimination is possible;
5. will operate from 20 to 150° C. oil temperature;
6. By providing an analogue output, the size and shape of particles can be determined.

In one embodiment only 6 watts is necessary to operate the apparatus and inexpensive circuitry is used.

In some embodiments, the oil flow passageway is divided into multiple narrow paths each having a respective coil which would allow for a high sensitivity to be gained whilst retaining high oil flow.

Under certain circumstances, apparatus for detecting electrically-conductive debris that employ a single or set of coils may fail to detect some types of particles. Referring to FIG. 5, this may occur, for example where a particle 102 having a small extent along one axis but a relatively large extent along the other axes travels through the apparatus with the one axis approximately parallel to the passageway axis 101. Hence, the centre line of the smallest dimension is at an angle of approximately 90 degrees to the passageway axis. This means that the apparatus as previously described may be unaffected by the particle, as the apparatus only “sees” the narrow dimension. Particles of this general type may be indicative of imminent catastrophic machine failure.

To overcome this, the apparatus may be improved by inducing flow rotation in the flow path so that any particles that are present would be more easily detected. By provision of rotational flow in the flow pipe such particles will spin and that increases the prospect of being detected since, at some point during the spin, it is likely that the width dimension would be presented to the coil for detection.

Another way to overcome this possible defect is to use two or more coils 10a, 10b. In one embodiment, shown in FIG. 6, there are two coils having respective axes 103, 104, disposed such that their axes 103, 104 do not lie parallel to the axis 101 of the flow passageway and are at different angles to the axis of flow. In the example shown, axis 103 makes an angle of around 60 degrees to passageway axis 101, and axis 104 makes an angle of around 120 degrees to axis 101. In another embodiment there are two coils, one having its axis parallel to the flow direction and one having its axis angled to the flow direction. In yet other embodiments two coils are at substantially unrelated angles to the axis.

These and similar embodiments produce a signal in one or both of the coils regardless of the particle orientation. With this arrangement it is also possible to determine the shape characteristics of a particle as the signal from each coil will only differ if the particle is not spherical. i.e. a perfect sphere will produce exactly the same signal in both coils.

As these plural coil arrangements do not rely for their operation on the absolute difference in position of the coils being constant, they are not vibration sensitive in the way that known plural coil apparatus can be.

It is possible to use separate signal processing circuits for each coil. It is alternatively possible to dispose the coils electrically in series. The angle and number of coils in use will vary depending on the application.

Although the device has been described using positive controlled resistance or capacitance circuitry, it would of course be possible to substitute negative impedance simulators if so required.

Although exemplary embodiments of the invention have been described with respect to the accompanying drawings, the scope of the invention is not restricted to features of the embodiment but instead extends to the scope of the appended claims.

1-25. (canceled)

26. Apparatus for detecting the presence of electrically-conductive debris in a flow passageway, the apparatus comprising a bridge circuit having four arms, one arm of the bridge comprising a coil arranged to monitor the flow passageway, operating circuitry for providing alternating current across one diagonal of the bridge, monitoring circuitry for monitoring imbalance in the bridge across the other diagonal of the bridge, and balancing circuitry responsive to an output of the monitoring circuitry for adjusting the value of at least one component of the bridge circuit in such a way to reduce imbalance in the bridge.

27. The apparatus of claim 26, wherein the coil comprises only a single coil.

28. The apparatus of claim 26, in combination with means defining a flow passageway wherein the operating circuitry, the monitoring circuitry, the balancing circuitry and components of the bridge circuit other than the coil is arranged to be capable of being disposed remote from said means defining the flow passageway.

29. The apparatus of claim 26, wherein the balancing circuitry is be arranged to control at least one of the group comprising capacitive reactance, inductive reactance and resistance of said at least one component.

30. The apparatus of claim 26, wherein the monitoring circuitry comprises synchronous detectors for measuring in-phase and quadrature components of voltage in said other diagonal of the bridge.

31. The apparatus of claim 26, wherein the operating circuitry comprises circuitry for applying a sine wave across said one diagonal as said alternating current.

32. The apparatus of claim 26, wherein said one arm comprises the series circuit of said coil and a capacitor device, and the remaining three arms are formed of elements whose impedance effect is substantially resistive.

33. The apparatus of claim 32, wherein the capacitor device is controllable.

34. The apparatus of claim 32, wherein said one arm comprises a transformer having a primary and secondary winding, the primary winding being disposed in series with the capacitive device and the secondary winding being connected to said coil.

35. The apparatus of claim 26, wherein the balancing circuitry comprises a controllable capacitance connected in parallel with a fixed capacitor in said one arm.

36. The apparatus of claim 35, wherein the controllable capacitance comprises a fixed capacitor and circuitry for controllably feeding alternating current to the capacitor, whereby the effect of the fixed capacitor is controlled.

37. The apparatus of claim 26, wherein the balancing circuitry comprises a controllable resistance connected in parallel with a fixed resistor in one of the arms of the bridge circuit.

38. Apparatus for detecting the presence of electrically-conductive debris in a flow passageway, the apparatus comprising a coil arranged to monitor the passageway, drive circuitry for providing alternating current through the coil, sensing circuitry for monitoring current flow in the coil, the sensing circuitry comprising compensation circuitry for compensating for ageing and temperature effects, wherein the drive circuitry comprises components which with the coil form a bridge circuit such that the coil is disposed in one arm of the bridge circuit, and wherein the compensation circuitry is arranged to control at least one of the group comprising capacitive reactance, inductive reactance and resistance of one of more said components.

39. The apparatus of claim 38, wherein said coil comprises only a single coil.

40. The apparatus of claim 38, in combination with means defining a flow passageway wherein the operating circuitry, the monitoring circuitry, the balancing circuitry and components of the bridge circuit other than the coil are arranged to be capable of being disposed remote from said means defining the flow passageway.

41. The apparatus of claim 38, wherein the sensing circuitry comprises synchronous detectors for measuring in-phase and quadrature components of voltage in a diagonal of the bridge circuit.

42. The apparatus of claim 38, wherein the bridge circuit comprises four arms, said one arm comprising a series circuit of said coil and a capacitive device, and the remaining three arms being formed of elements whose impedance effect is substantially resistive.

43. The apparatus of claim 38, wherein the drive circuitry comprises a source of sine wave oscillations coupled to one diagonal of the bridge circuit.

44. The apparatus of claim 38, wherein the capacitive device is controllable.

45. The apparatus of claim 38, wherein said one arm comprises a transformer having a primary and a secondary winding, the primary winding being disposed in series with the capacitive device and the secondary winding being connected to sad coil.

46. The apparatus of claim 38, wherein the compensation circuitry comprises a controllable capacitance connected in parallel with a fixed capacitor in said one arm.

47. The apparatus of claim 38, wherein the controllable capacitance comprises a fixed capacitor and circuitry for controllably feeding alternating current to the capacitor, whereby the effect of the fixed capacitor is controlled.

48. The apparatus of claim 38, wherein the compensation circuitry comprises a controllable resistance connected in parallel with a fixed resistor in one of sad remaining arms of the bridge circuit.

49. The apparatus of claim 38, wherein the controllable resistance comprises a fixed resistor and circuitry for controllably feeding alternating current of the resistor, whereby the effect of the fixed resistor is controlled.

50. The apparatus of claim 38, wherein plural coils are provided, at least one of which has an axis that is not aligned with the flow passage axis, for determining the shape of any particles, or for ensuring detection of highly-asymmetric particles such as thin wide particles.
